(19) United States
(12) Patent Application Publication
(10) Pub. No.: US 2026/0343415 A1
(43) Pub. Date: Oct. 29, 2026

(54) FLEXIBLE CONFIGURATIONS FOR DIFFERENT SERVICES AND DEVICES IN WIRELESS COMMUNICATIONS SYSTEMS

(71) Applicant: QUALCOMM Incorporated, San Diego, CA (US)

(72) Inventors: Le LIU, San Jose, CA (US); Alberto RICO ALVARINO, San Diego, CA (US)

(21) Appl. No.: 19/548,675

(22) Filed: Feb. 24, 2026

Related U.S. Application Data
(60) Provisional application No. 63/796,921, filed on Apr. 29, 2025.

(51) Int. Cl. H04W 52/02; H04L 5/00; H04W 76/27

(52) U.S. Cl. CPC H04W 52/0235; H04L 5/0094; H04W 76/27

(57) ABSTRACT

This disclosure provides methods, components, devices and systems for flexible configurations for different services and devices in wireless communications systems. The described techniques provide for a bandwidth part (BWP) configuration that supports flexible parameters that may be appliable to multiple different services or types of services for a user equipment (UE). For example, a network entity may indicate a BWP configuration to a UE that maps association identifiers (IDs) to various combinations of uplink configurations, downlink configurations, discontinuous reception (DRX) configurations, wakeup signal (WUS) configurations, or any combination thereof. The association ID may support a respective type of service associated with a radio network temporary ID (RNTI) and may map different RNTIs configured for the UE to different combinations of PDCCH parameters, PDSCH parameters, semi-persistent scheduling (SPS) parameters, and DRX parameters, and, in some cases, wakeup signal (WUS) configurations.

### CROSS REFERENCES

This Patent application claims the benefit of U.S. Provisional Patent Application No. 63/796,921 by LIU et al., entitled “FLEXIBLE CONFIGURATIONS FOR DIFFERENT SERVICES AND DEVICES IN WIRELESS COMMUNICATIONS SYSTEMS,” filed Apr. 29, 2025, assigned to the assignee hereof, and expressly incorporated herein.

### TECHNICAL FIELD

This disclosure relates generally to wireless communication, and more specifically to systems, devices, methods, and techniques associated with flexible configurations for different services and devices in wireless communications systems.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

Wireless communications may be performed in accordance with one or more different services or types of services. For example, a wireless device may communicate information for unicast services (e.g., one-to-one data transmission between wireless devices), multicast services (e.g., one-to-many data transmission between a first wireless device and a configured group of second wireless devices), broadcast services (e.g., one-to-many data transmission between a first wireless device and other second wireless devices connected to the first wireless device via a network), or any combination thereof. In some examples, parameters for performing different services or types of services may be configured via control signaling.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include receiving control signaling including a bandwidth part (BWP) configuration that allocates a BWP for subsequent communications by the UE, where the BWP configuration indicates a set of multiple candidate configurations for the subsequent communications via the BWP and maps each candidate configuration of the set of multiple candidate configurations to a respective association for a respective type of service supported by each candidate configuration, the set of multiple candidate configurations including one or more uplink configurations, one or more downlink configurations, one or more discontinuous reception (DRX) configurations, or any combination thereof, receiving a message indicating an association for a type of service, the association indicative of a configuration of the set of multiple candidate configurations that supports the type of service, and communicating, via the BWP and in accordance with the configuration, information for the type of service based on the message indicating the association.

A UE for wireless communications is described. The UE may include a processing system that includes processor circuitry and memory circuitry that stores code. The processing system may be configured to cause the UE to receive control signaling including a BWP configuration that allocates a BWP for subsequent communications by the UE, where the BWP configuration indicates a set of multiple candidate configurations for the subsequent communications via the BWP and maps each candidate configuration of the set of multiple candidate configurations to a respective association for a respective type of service supported by each candidate configuration, the set of multiple candidate configurations including one or more uplink configurations, one or more downlink configurations, one or more DRX configurations, or any combination thereof, receive a message indicating an association for a type of service, the association indicative of a configuration of the set of multiple candidate configurations that supports the type of service, and communicate, via the BWP and in accordance with the configuration, information for the type of service based on the message indicating the association.

Another UE for wireless communications is described. The UE may include means for receiving control signaling including a BWP configuration that allocates a BWP for subsequent communications by the UE, where the BWP configuration indicates a set of multiple candidate configurations for the subsequent communications via the BWP and maps each candidate configuration of the set of multiple candidate configurations to a respective association for a respective type of service supported by each candidate configuration, the set of multiple candidate configurations including one or more uplink configurations, one or more downlink configurations, one or more DRX configurations, or any combination thereof, means for receiving a message indicating an association for a type of service, the association indicative of a configuration of the set of multiple candidate configurations that supports the type of service, and means for communicating, via the BWP and in accordance with the configuration, information for the type of service based on the message indicating the association.

A non-transitory computer-readable medium storing code for wireless communications is described. The code may include instructions executable by one or more processors to receive control signaling including a BWP configuration that allocates a BWP for subsequent communications by the UE, where the BWP configuration indicates a set of multiple candidate configurations for the subsequent communications via the BWP and maps each candidate configuration of the set of multiple candidate configurations to a respective association for a respective type of service supported by each candidate configuration, the set of multiple candidate configurations including one or more uplink configurations, one or more downlink configurations, one or more DRX configurations, or any combination thereof, receive a message indicating an association for a type of service, the association indicative of a configuration of the set of multiple candidate configurations that supports the type of service, and communicate, via the BWP and in accordance with the configuration, information for the type of service based on the message indicating the association.

In some examples of the method, UEs, and non-transitory computer-readable medium described herein, the one or more downlink configurations indicated via the control signaling include one or more physical downlink shared channel (PDSCH) configurations, each PDSCH configuration of the one or more PDSCH configurations including a frequency domain resource allocation (FDRA) that indicates a subset of frequency resources within the BWP allocated for a PDSCH, a quantity of multiple-input multiple-output layers for the PDSCH, or both.

In some examples of the method, UEs, and non-transitory computer-readable medium described herein, the one or more downlink configurations indicated via the control signaling include one or more physical downlink control channel (PDCCH) configurations, one or more PDSCH configurations, and one or more semi-persistent scheduling (SPS) configurations; the association indicates a PDCCH configuration of the one or more PDCCH configurations, a PDSCH configuration of the one or more PDSCH configurations, and a SPS configuration of the one or more SPS configurations that support the type of service; and communicating the information for the type of service may be in accordance with the PDCCH configuration indicated by the association.

In some examples of the method, UEs, and non-transitory computer-readable medium described herein, each PDCCH configuration of the one or more PDCCH configurations includes a set of one or more control resource sets (CORESETs) for a respective PDCCH, a set of one or more search spaces (SSs) of the respective PDCCH, or both; and each PDSCH configuration of the one or more PDSCH configurations includes a FDRA for a respective PDSCH, a quantity of multiple-input multiple-output (MIMO) layers for the respective PDSCH, or both.

In some examples of the method, UEs, and non-transitory computer-readable medium described herein, the one or more PDCCH configurations include a single PDCCH configuration that indicates a set of multiple CORESETs of a downlink control channel, a set of multiple SS sets of the downlink control channel, or both; the association further indicates the single PDCCH configuration and a CORESET, of the set of multiple CORESETs indicated via the single PDCCH configuration, a SS set, of the set of multiple SS sets indicated via the single PDCCH configuration, or both that supports the type of service; and communicating the information for the type of service may be further accordance with the CORESET, the SS set, or both indicated by the association.

In some examples of the method, UEs, and non-transitory computer-readable medium described herein, the control signaling includes one or more IDs for one or more respective types of service; and the association indicates an ID of the one or more IDs indicated via the control signaling and a DRX configuration of the one or more DRX configurations indicated via the control signaling based on the ID.

In some examples of the method, UEs, and non-transitory computer-readable medium described herein, and the method, apparatuses, and non-transitory computer-readable medium may include further operations, features, means, or instructions for monitoring for a wakeup signal (WUS) in accordance with the WUS configuration based on the association.

In some examples of the method, UEs, and non-transitory computer-readable medium described herein, each WUS configuration of the one or more WUS configurations may be mapped to at least one DRX configuration of the one or more DRX configurations indicated via the control signaling; and the association indicates the WUS configuration based on the association indicating a DRX configuration that may be mapped to the WUS configuration.

In some examples of the method, UEs, and non-transitory computer-readable medium described herein, each WUS configuration of the one or more WUS configurations may be mapped to at least one PDCCH configuration of the one or more downlink configurations indicated via the control signaling; and the association indicates the WUS configuration based on the association indicating a PDCCH configuration mapped to the WUS configuration.

In some examples of the method, UEs, and non-transitory computer-readable medium described herein, the one or more uplink configurations indicated via the control signaling include one or more physical uplink control channel (PUCCH) configurations; each PUCCH configuration of the one or more PUCCH configurations indicates whether a feedback process may be enabled for a respective PUCCH, indicates a codebook type of the respective PUCCH, or both; the association further indicates a PUCCH configuration, of the one or more PUCCH configurations, that supports the type of service; and communicating the information for the type of service may be further accordance with the PUCCH configuration indicated by the association.

Some examples of the method, UEs, and non-transitory computer-readable medium described herein may further include operations, features, means, or instructions for receiving second control signaling including one or more UE types for one or more types of services and receiving a second message indicating a second association, where the second association may be indicative of a UE type for the UE, and where the UE type for the UE may be based on capabilities of the UE while operating in a radio resource control idle or inactive mode.

Some examples of the method, UEs, and non-transitory computer-readable medium described herein may further include operations, features, means, or instructions for receiving second control signaling including one or more second candidate configurations for performing a small data transmission (SDT) and receiving a second message indicating a second association indicative of a second configuration of the one or more second candidate configurations for performing the SDT while operating in a radio resource control idle or inactive mode.

In some examples of the method, UEs, and non-transitory computer-readable medium described herein, the second association further indicates a UE type for the UE that may be based on capabilities of the UE while operating in an idle or inactive mode.

In some examples of the method, UEs, and non-transitory computer-readable medium described herein, the one or more uplink configurations indicated via the control signaling include one or more physical uplink shared channel (PUSCH) configurations, each PUSCH configuration of the one or more PUSCH configurations including a FDRA that indicates a subset of frequency resources within the BWP allocated for a PUSCH.

### BRIEF DESCRIPTION OF THE DRAWINGS

FIG. 1 shows an example of a wireless communication system.

FIG. 2 shows an example of a signaling configuration that supports flexible configurations for different services and devices in wireless communications systems.

FIG. 3 shows an example of a process flow that supports flexible configurations for different services and devices in wireless communications systems.

FIG. 4 shows a block diagram of a processing system that supports flexible configurations for different services and devices in wireless communications systems.

FIG. 5 shows a diagram of a system including a device that supports flexible configurations for different services and devices in wireless communications systems.

FIG. 6 shows a flowchart illustrating methods that support flexible configurations for different services and devices in wireless communications systems.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a user equipment (UE) may communicate via one or more bandwidth parts (BWPs), which may be a portion of a frequency range of a wireless channel between the UE and other wireless devices (e.g., network entities, other UEs). In some cases, the UE may receive one or more configurations for communicating via a BWP, where the one or more configurations may be for communicating according to one or more types of service. For example, the UE may receive a first BWP configuration for performing unicast services (e.g., voice, video streaming, online gaming, email) and may receive a second BWP configuration for performing multicast-broadcast (MBS) services (e.g., high definition (HD) video streams, radio, file transfer). In some cases, the different BWP configurations may include common parameters for communicating according to a respective type of service, such as downlink channel configurations (e.g., physical downlink control channel (PDCCH) or physical downlink shared channel (PDSCH) configurations), uplink channel configurations (e.g., physical uplink control channel (PUCCH) or physical uplink shared channel (PUSCH) configurations), discontinuous reception (DRX) configurations, and wakeup signal configurations, among other examples. However, different types of services, or different services within a same type of service, may have different quality of service (QoS) constraints, and common parameters configured for different services may be unable to optimize a resource allocation to satisfy such QoS constraints, thereby limiting a flexibility of a BWP configuration to be applicable to multiple services and types of services, which result in increased signaling overhead when scheduling different services or types of services for a UE.

Aspects of the subject matter described in this disclosure relate to a BWP configuration that supports flexible parameters that may be appliable to multiple different services or types of services for a UE. For example, a network entity may indicate a BWP configuration to a UE (e.g., via radio resource control (RRC) signaling) that maps associations (e.g., association identifiers (IDs)) to various combinations of uplink configurations, downlink configurations, discontinuous reception (DRX) configurations, wakeup signal (WUS) configurations, or any combination thereof. In some cases, an association ID may support a respective type of service (e.g., a unicast service, a multicast service, a broadcast service) associated with a radio network temporary ID (RNTI). For example, the BWP configuration may indicate a list of PDSCH configurations each including a respective bandwidth for a PDSCH frequency domain resource allocation (FDRA), a list of PDCCH configurations each including respective control resource set (CORESET) and search space (SS) information for a PDCCH, or both, among other examples. Additionally, or alternatively, an association ID may map different RNTIs configured for the UE (e.g., configured via separate control signaling from the BWP configuration) to different combinations of PDCCH parameters, PDSCH parameters, semi-persistent scheduling (SPS) parameters, and DRX parameters, and, in some cases, wakeup signal (WUS) configurations. In some examples, the network entity may activate or deactivate an association ID via dynamic signaling (e.g., a medium access control control element (MAC-CE) or a downlink control information (DCI) message). Additionally, or alternatively, the network entity may indicate BWP configuration information for the UE to use while operating in an idle or inactive mode, such as by indicating an association ID for a type of the UE (e.g., according to UE capabilities to receive MBS signaling while idle or inactive), an association ID configuring a small data transmission (SDT), or both.

Particular aspects of the subject matter described in this disclosure can be implemented to realize one or more of the following potential advantages. In some examples, by configuring a BWP with flexible parameters for different types of services, the described techniques can be used to reduce signaling overhead and/or processing complexity associated with performing BWP switching when performing communications for different types of services. In some examples, a flexible BWP may prevent a network from defining a common frequency resource (CFR) or subset of the BWP for the multiple different services or types of services, thereby reducing complexity of the BWP configuration and signaling overhead for configuring the BWP. In some examples, the UE may efficiently communicate control information and data for the multiple different services or types of services without incurring addition latency for BWP switching.

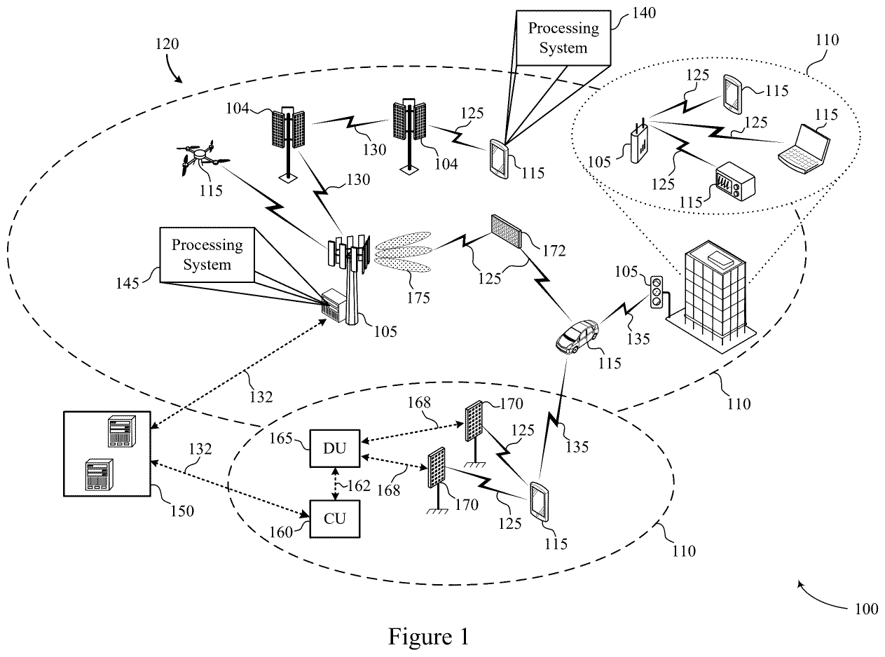

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, BWPs, or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a PDSCH for communicating user data in a downlink direction and a PUSCH for communicating user data in an uplink direction. Physical control channels (such as for managing communication via physical channels) may include a physical PDCCH for communicating DCI and a physical uplink PUCCH for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a CORESET) for a physical control channel may be configured in accordance with a pattern of REs in the time and frequency domains, and one or more control regions may be configured for a set of UEs. A UE 115 may monitor control regions for control information according to one or more SS sets, which may include a common SS set (such as for sending control information to one or more UEs 115), UE-specific SS sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, where the device may provide HARQ feedback in a specific slot for data received via a previous symbol of the slot. In some other examples, the device may provide HARQ feedback via a subsequent slot or according to some other time interval.

Other techniques for reducing power consumption at UEs 115 may include a low-power wake up radio (LP-WUR). The LP-WUR may receive one or more signals while a UE 115 is in a sleep mode. For example, the LP-WUR may receive low-power wakeup signal (LP-WUS) or low-power synchronization signal (LP-SS) transmissions. The LP-WUS transmissions may indicate for the UE 115 to transition to an awake state and power on a main radio to perform wireless communications with another device (e.g., with the network entity 105). The LP-SS transmissions may be used by the LP-WUR for time and frequency synchronizations or channel measurements for the UE 115.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or RBs) within a carrier, within a guard-band of a carrier, or outside of a carrier.

Devices of the wireless communication system 100 may be configured to support one or more aspects of the described techniques for flexible configurations for different services and devices in wireless communications systems. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support a BWP configuration that supports flexible parameters that may be appliable to multiple different services or types of services for a UE 115.

For example, a network entity 105 may indicate a BWP configuration to a UE 115 (e.g., via RRC signaling) that maps association IDs to various combinations of uplink configurations, downlink configurations, DRX configurations, WUS, or any combination thereof. In some cases, an association ID may support a respective type of service (e.g., a unicast service, a multicast service, a broadcast service) associated with an RNTI. For example, the BWP configuration may indicate a list of PDSCH configurations each including a respective bandwidth for a PDSCH FDRA, a list of PDCCH configurations each including respective CORESET and SS information for a PDCCH, or both, among other examples. Additionally, or alternatively, an association ID may map different RNTIs configured for the UE 115 (e.g., configured via separate control signaling from the BWP configuration) to different combinations of PDCCH parameters, PDSCH parameters, SPS parameters, and DRX parameters, and, in some cases, WUS configurations. In some examples, the network entity 105 may activate or deactivate an association ID via dynamic signaling (e.g., a MAC-CE or a DCI message). Additionally, or alternatively, the network entity 105 may indicate BWP configuration information for the UE 115 to use while operating in an idle or inactive mode, such as by indicating an association ID for a type of the UE 115 (e.g., according to UE capabilities to receive MBS signaling while idle or inactive), an association ID configuring an SDT, or both.

Particular aspects of the subject matter described in this disclosure can be implemented to realize one or more of the following potential advantages. In some examples, by configuring a BWP with flexible parameters for different types of services, the described techniques can be used to reduce signaling overhead and/or processing complexity associated with performing BWP switching when performing communications for different types of services.

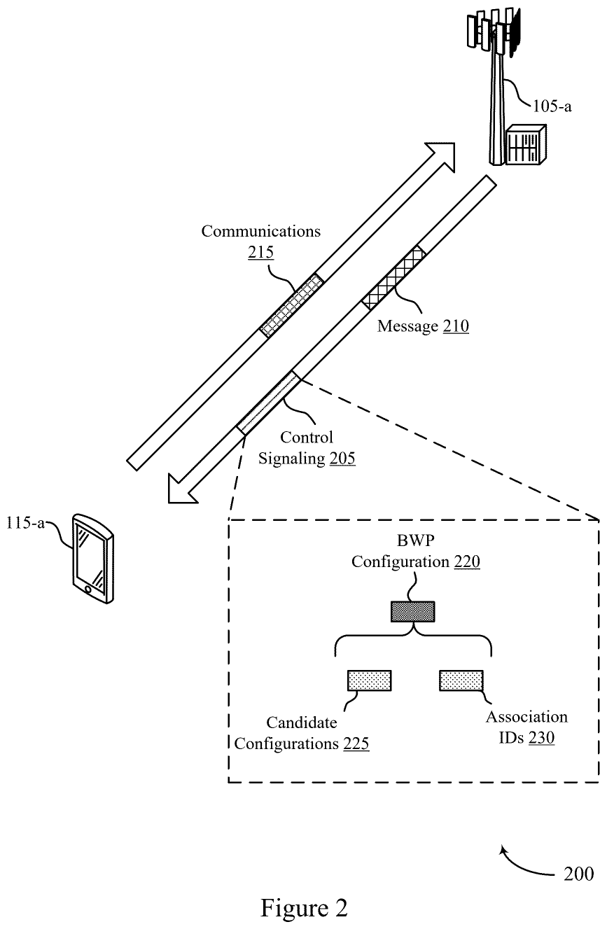

FIG. 2 shows an example of a signaling configuration 200 that supports flexible configurations for different services and devices in wireless communications systems. The signaling configuration 200 may implement, or be implemented by, one or more aspects of the wireless communications system 100. For example, the signaling configuration 200 illustrates signaling between a network entity 105-a and a UE 115-a, which may be examples of corresponding devices described with reference to FIG. 1. In some examples, the signaling configuration 200 may support a flexible BWP configuration for supporting different services or types of service for the UE 115-a, as well as supporting scheduling services for different types of UEs 115.

The UE 115-a may support communications in accordance with one or more different services or types of services. For example, the UE 115-a may support unicast services (e.g., a one-to-one transmission of data between the UE 115-a and the network entity 105-a). In some examples, the network entity 105-a may transmit a BWP configuration to the UE 115-a to support unicast communications. The BWP configuration for unicast services may include an initial downlink BWP, which may include PDCCH parameters (e.g., CORESET and SS information for the PDCCH) and PDSCH parameters configured for communicating a system information block (SIB), paging information, random access signaling, or any combination thereof. The BWP configuration for unicast services may further include a dedicated downlink BWP, which may include PDCCH parameters (e.g., CORESET and SS information for the PDCCH), PDSCH parameters and SPS parameters that are configured for shared unicast services (e.g., different services that are each a unicast service).

In some cases, the network entity 105-a may schedule unicast services using one or more RNTIs, such as a cell RNTI (C-RNTI), a modulation coding scheme C-RNTI (MCS-C-RNTI), and a configured scheduling RNTI (CS-RNTI). For example, the network entity 105-a may indicate a C-RNTI for a unicast PDCCH to schedule unicast PDSCH or PUSCH messages, may indicate a CS-RNTI for a unicast PDCCH to activate or deactivate SPS PDSCH messages and retransmissions of the SPS PDSCH messages, and may indicate an MCS-C-RNTI to indicate an alternative MCS table (e.g., qam64LowSE) for PDSCH and PUSCH grant-based transmissions. Additionally, or alternatively, the UE 115-a may implement a DRX configuration, where the UE 115-a may reduce power by entering a low-power mode (e.g., turning off a main radio) and monitoring for a WUS or paging early indication (PEI) from the network entity 105-a. In some examples, the DRX configuration and parameters for communicating the WUS or PEI may be configured by the network entity 105-a to be applicable to unicast services (e.g., applicable to all unicast services).

The UE 115-a may additionally, or alternatively, support MBS services. For example, the UE 115-a may support broadcast services (e.g., the network entity 105-a may transmit messages to multiple UEs 115 connected to the network entity 105-a, such as the UE 115-a) and multicast services (e.g., the network entity 105-a may transmit messages to multiple UEs 115 of a configured group including the UE 115-a). In some examples, the network entity 105-a may configure the UE 115-a with a CFR for communicating information for MBS services.

For example, the network entity 105-a may configure a CFR for broadcast services, which may be frequency resources that include at least the initial downlink BWP resources (e.g., CFR for broadcast may be greater than or equal to a CORESET0 or initial downlink BWP configured for unicast services). The CFR of broadcast services may be configured with parameters for a PDCCH (e.g., CORESET and SS information for PDCCH) and a PDSCH for communicating broadcast information (e.g., configuration of CFR for broadcast may be shared for MBS broadcast services). Additionally, or alternatively, the network entity 105-a may configure a CFR for multicast services, which may be frequency resources included within the dedicated downlink BWP resources (e.g., CFR for multicast may be less than or equal to the dedicated downlink BWP configured for unicast services). The CFR for multicast services may be configured with parameters for a PDCCH (e.g., CORESET and SS information for the PDCCH) and a PDSCH for communicating multicast information (e.g., configuration of CFR for multicast may be shared for MBS multicast services). In some examples, the PDCCH configuration for multicast services may include CORSET and SS information that is separately configured, while other parameters of the PDCCH configuration may not be separately configured for multicast services (e.g., the other parameters may be non-essential for MBS multicast services).

In some examples, for MBS services, the network entity 105-a may use one or more group RNTIs (G-RNTIs) or group configured scheduling RNTIs (G-CS-RNTIs) for scheduling one or more MBS multicast traffic channel (MTCH) services (e.g., one G-RNTI or G-CS-RNTI may be used per MBS service). In some examples, the UE 115-a may support a DRX point-to-multipoint (PTM) configuration for MBS services, where the DRX-PTM configuration may be configured per G-RNTI, which may be different for different MBS MTCH services (e.g., the active and inactive durations of the DRX-PTM configuration may be different for different MBS services according to the G-RNTI). In some cases, a WUS or PEI may not be configured for MBS services (e.g., the UE 115-a may monitor active durations of the DRX-PTM configuration regardless of whether a WUS or PEI is received).

The network entity 105-a may configure control and data scheduling resources for unicast, multicast, and broadcast separately. For example, a BWP configuration, PDCCH parameters, and PDSCH parameters may be common for different unicast services and a CFR configuration, PDCCH parameters, and PDSCH parameters may be common for MBS services. In some cases, different unicast services and different MBS services may be associated with different QoS constraints, such as bandwidth, data rate, latency, reliability, and priority, among other examples. For example, unicast services may include voice service, video streaming service, online gaming service, and email service, among other examples, which each may have different QoS constraints. Similarly, MBS services may include HD video stream service, radio, service, and file transfer service, among other examples, which each may have different QoS constraints. In some cases, however, common parameters configured for different services may be unable to optimize a resource allocation to satisfy the different QoS constraints (e.g., common control and data scheduling resources may not be sufficient to support different services within a same service type). Additionally, the UE 115-a may perform BWP switching to support different types of services that have separate configurations, which may incur additional signaling overhead and processing complexity for such BWP switching. Further, common configurations for different services may limit power saving benefits of a DRX configuration, for example due to one DRX configuration being configured for unicast (e.g., where a C-RNTI is used for all types of unicast services) and the UE 115-a continuing to monitor active durations of a DRX configuration for MBS services (e.g., more than one DRX configuration may be separately configured for MBS per G-RNTI, but the UE will still monitor active durations of common DRX configurations for different MBS services).

Techniques described herein provide for a BWP configuration framework that is common for unicast services and MBS services and supports flexible parameters for control and data scheduling resources for different services and different types of services. Such configurations may support the UE 115-a communicating according to different services or types of services without performing BWP switching or receiving additional configurations information, which may reduce signaling overhead, latency, and processing complexity at the UE 115-a. Additionally, such configurations may be applicable to when the UE 115-a is operating in a connected mode (e.g., an RRC connected state) as well as when the UE 115-a is operating in a non-connected mode (e.g., an RRC idle or RRC inactive state). In some examples, the network entity 105-a may transmit control signaling 205 to the UE 115-a. The control signaling 205 may be an example of an RRC message that includes a BWP configuration 220 allocating a BWP for subsequent communications by the UE 115-a operating in a connected mode. The BWP configuration 220 may include a total bandwidth for a downlink bandwidth part (e.g., a bandwidth less than or equal to a carrier bandwidth), an SCS and CP for the BWP, a PDCCH configuration, a PDSCH configuration, and a list of SPS configurations. In some cases, the BWP configuration 220 may map candidate configurations 225 (e.g., combinations of configuration parameters) to association IDs 230 for different types of services.

In some cases, the PDSCH configuration may include additional parameters for flexible PDSCH bandwidth and/or MIMO layers. For example, the network entity 105-a may include, in the PDSCH configuration of the BWP configuration 220, a bandwidth for a PDSCH FDRA, which may be a subset of frequency resources of the BWP allocated for a PDSCH (e.g., a flexibly configured PDSCH bandwidth for supporting a certain service or type of service). Including the bandwidth for the PDSCH FDRA may enable the network entity 105-a to schedule different services or types of services for the UE 115-a without configuring a CFR with the BWP or another BWP so support PDSCH configurations with different maximum bandwidth constraints. Additionally, or alternatively, the network entity 105-a may include, in the PDSCH configuration of the BWP configuration 220, a quantity of MIMO layers (e.g., maxMIMO-Layers) for the PDSCH, which may support the UE 115-a determining codewords for an associated PDCCH. In some cases, the quantity of MIMO layers for the PDSCH may be less than or equal to a quantity of MIMO layers for the BWP (e.g., maxMIMO-Layers for the PDSCH may be less than or equal to maxMIMO-Layers for the BWP).

In some examples, the BWP configuration 220 may include a list of one or more PDCCH configurations and a list of one or more PDSCH configurations. Each PDCCH configuration of the one or more PDCCH configurations may include a list of one or more CORESETs (e.g., each including a bandwidth and control channel element (CCE) mapping for a respective CORESET) and a list of one or more SS sets (e.g., each including a periodicity, type, and aggregation level (AL) for a respective SS set). Each PDSCH configuration of the one or more PDSCH configurations may include a bandwidth for a respective PDSCH FDRA and a quantity of MIMO layers for the respective PDSCH. In some examples, the BWP configuration 220 may indicate a mapping between combinations of configuration parameters and different services (e.g., for communicating within the BWP). For example, a combination of an RNTI, a PDCCH configuration of the one or more PDCCH configurations (e.g., PDCCH-Config(i)), a PDSCH configuration of the one or more PDSCH configurations (e.g., PDSCH-configj)), and an SPS configuration (e.g., of the list of SPS configurations included in the BWP configuration 220) may be configured to support a service within a BWP. Alternatively, the BWP configuration 220 may include a single PDCCH configuration and the list of one or more PDSCH configurations. For example, the PDCCH configuration may include a list of CORSETs and a list of SS sets, and the BWP configuration 220 may indicate combinations of an RNTI, a CORESET and SS set of the PDCCH configuration (e.g., selected from the list of CORSETs and the list of SS sets), a PDSCH configuration of the one or more PDSCH configurations, and an SPS configuration that are mapped to different services. Such configurations may enable the UE 115-a to monitor a PDCCH and PDSCH associated with different services without performing BWP switching, which may reduce signaling overhead and processing complexity associated with the BWP switching.

In some examples, the network entity 105-a may activate or deactivate a combination of configuration parameters via a message 210. The message 210 may be an example of a dynamic indication, such as a MAC-CE or a DCI message. In some cases, the message 210 may include an association ID 230 for a combination of communication parameters. For example, the message 210 may schedule communications for a service or type of service, and may include an association ID 230 for the service or type of service that is mapped to a candidate configuration 225 in the BWP configuration 220 (e.g., a combination of configuration parameters). As an example, the UE 115-a may identify, based on the association ID 230 and an RNTI for the service, a combination of a PDCCH configuration (e.g., a PDCCH configuration from a list of PDCCH configurations or a CORESET and SS set from a single PDSCCH configuration), a PDSCH configuration (e.g., a PDSCH configuration from a list of PDSCH configurations), and an SPS configuration for communicating the service or type of service scheduled by the message 210.

In some cases, the BWP configuration 220 may include a list of DRX configurations for the UE 115-a to use while communicating within the BWP. For example, the control signaling 205 may include a list of DRX configurations and may include a DRX configuration in the candidate configurations 225 for different types of services. In some examples, a combination of a DRX configuration, a PDCCH configuration, a PDSCH configuration, and an SPS configuration can be associated with a service RNTI. For example, an association ID 230 may map a combination (e.g., a candidate configuration 225) of RNTI, PDCCH configuration, PDSCH configuration, SPS configuration, and DRX configuration (e.g., asstID={RNTI(r), PDCCH(i), PDSCH(j), SPS(s), DRX(d)}) to a service. As an example, a first association ID 230 may indicate a first candidate configuration 225 for a first service (e.g., asst1={RNTI1, PDCCH1, PDSCH1, SPS1, DRX1}), a second association ID 230 may indicate a second candidate configuration 225 for a second service (e.g., asst2={RNTI2, PDCCH2, PDSCH1, SPS2, DRX2}), a third association ID 230 may indicate a third candidate configuration 225 for a third service (e.g., asst3={RNTI3, PDCCH2, PDSCH2, SPS2, DRX2}), and so on. Such configurations may support a flexible mapping of candidate configurations 225 for different services with an efficient resource allocation and enhanced power saving capabilities (e.g., an M-to-N mapping between DRX configurations and RNTIs). In some examples, a quantity of the PDCCH configurations, the PDSCH configurations, and the DRX configurations may be based on capabilities of the UE 115-a. For example, the UE 115-a may transmit a capability report to the network entity 105-a and the network entity 105-a may configure the quantity of PDCCH configurations, PDSCH configurations, and DRX configurations in the BWP configuration 220 according to the capability report.

In some cases, the message 210 (e.g., a MAC-CE) indicated by the PDCCH addressed to an RNTI may be used to activate or deactivate a candidate configuration 225. For example, the message 210 may be addressed to an RNTI and may indicate an association ID 230 that activates or deactivates a corresponding combination of a PDCCH configuration, a PDSCH configuration, an SPS configuration, and a DRX configuration.

In some examples, the BWP configuration 220 may include a list of WUS configurations. In some cases, the list of WUS configurations may be associated with the list of DRX configurations. For example, the UE 115-a may monitor an active duration of a DRX configuration (e.g., an active time of drx-onDurationTimer) based on the WUS configuration. As an example, a WUS configuration may be associated with one or more DRX configurations included in the BWP (e.g., WUS(w) may be associated with {DRX(d)}, which may be one or more multiple of the DRX configurations in the BWP configuration 220). As another example, a WUS configuration may be jointly configured as part of a candidate configuration 225 associated with an association ID 230 (e.g., asstID={RNTI(r), PDCCH(i), PDSCH(j), SPS(s), DRX(d), WUS(w)}) for a service. In some other examples, the list of WUS configurations may not be associated with the list of DRX configurations. For example, the UE 115-a may monitor a PDCCH after successfully detecting a WUS (e.g., independent of the PDCCH occasion being outside or inside a PDCCH active time window or whether the UE 115-a is configured with a DRX configuration). As an example, a WUS configuration may be associated with one or more PDCCH configurations (e.g., WUS(w) may be associated with {PDCCH(i)}). As another example, a WUS configuration may be jointly configured as part of a candidate configuration associated with an association ID 230 (e.g., asstID={RNTI(r), PDCCH(i), PDSCH(j), SPS(s), WUS(w)}) for a service.

If a WUS configuration is associated with DRX configurations or PDCCH configurations that are configured for more than one service, a WUS configured by the WUS configuration may carry information indicative of which DRX configuration or PDCCH configuration to monitor for an upcoming service. For example, the WUS may include a bitmap for different services (e.g., indicating the upcoming service). As another example, the WUS may include a service-specific sequence, or may include a common sequence if more than one service is active.

In some examples, the BWP configuration 220 may include parameters for communicating via an uplink BWP. For example, the BWP may configure an uplink BWP and may include a bandwidth for the BWP (e.g., a total bandwidth for the uplink BWP, which may be less than or equal to a carrier bandwidth), an SCS and CP for the uplink BWP, a PUCCH configuration for the uplink BWP (e.g., PUCCH-config), a PUSCH configuration for the uplink BWP (e.g., PUSCH-config), and a configured grant (CG) configuration for the uplink BWP, among other configuration parameters for the uplink BWP.

In some cases, the BWP configuration 220 for an uplink BWP may include a list of one or more PUCCH configurations or a subset of parameters in a PUCCH configuration (e.g., a subset of parameters in a single PUCCH-config). The list of one or more PUCCH configurations may support the UE 115-a performing feedback procedures (e.g., transmitting HARQ-ACK feedback) for PDCCH and PDSCH configurations associated with different services. For example, each PUCCH configuration of the one or more PUCCH configurations (e.g., a PUCCH-config(i)) may include a field indicating whether feedback is enabled or disabled (e.g., a HARQ-ACK disable/enable field) for the respective PUCCH configuration and may include a field indicating a codebook type for the respective PUCCH configuration. In some examples, including the list of one or more PUCCH configurations may support different PUCCH configurations used for communicating information for different services or types of service. For example, PUCCH resources and timing parameters (e.g., a K1 value indicative of a timing offset between a PDSCH slot and a UCI slot for transmitting feedback) may be separately configured for different PDCCH and PDSCH configurations that are associated with different RNTIs. Additionally, or alternatively, transmit power control (TPC) parameters for different DCI formats used in a SS set may be separately configured for different PDCCH and PDSCH configurations associated with different RNTIs. In some cases, each PUCCH configuration of the one or more PUCCH configurations may further include a field indicating resources for the respective PUCCH configurations, a field indicating resources for feedback (e.g., an SPS-PUCCH-AN-List field), a field indicating a PUCCH format, and a field indicating a timing for feedback (e.g., a DL-DataToUL-ACK field).

In some cases, the BWP configuration 220 for an uplink BWP may include a list of one or more PUSCH configurations. Including the list of one or more PUSCH configurations may support uplink configurations for different uplink data services. For example, each PUSCH configuration of the one or more PUSCH configurations may include a bandwidth for a respective PUSCH FDRA (e.g., frequency resources within the uplink BWP for a respective PUSCH configuration), which may prevent the network entity 105-a from configuring another uplink BWP to support PUSCH configurations with different bandwidth constraints (e.g., PUSCH configurations with different maxBW requirements). In some cases, a PUSCH configuration of the one or more PUSCH configurations, a CG configuration (e.g., of one or more CG configurations included in the uplink BWP configuration), or both may be associated with an RNTI and a PDCCH configuration for an uplink service. For example, the network entity 105-a may indicate, in the message 210, an association ID 230 indicative of the RNTI, a PDCCH configuration, a PUSCH configuration, and a CG configuration, among other examples (e.g., asstID={RNTI( ), PDCCH( ), PUSCH( ), CG( ), . . . }). In some cases, a scheduling request (SR) or buffer status report (BSR) (e.g., transmitted by the UE 115-a) may be configured to be associated with a downlink or uplink configuration for a service or type of service. For example, the SR or BSR may be associated with an association ID 230, and based on the association ID 230 the network entity 105-a may configure dynamic grant (DG) or CG resources to schedule a PUSCH transmission with the association ID 230 (e.g., asstID={RNTI( ), PDCCH( ), PUSCH( ), CG( ), . . . }). In some cases, based on the SR or BSR, the network entity 105-a may activate the association ID 230 (e.g., associated with the SR or BSR) via the message 210 (e.g., a MAC-CE or DCI message).

In some examples, the network entity 105-a may configure the UE 115-a to communicate in an RRC idle or RRC inactive mode. In some cases, the network entity 105-a may configure the UE 115-a to support different services (e.g., MBS services) based on capabilities of the UE 115-a (e.g., the network entity 105-a may support different MBS services for UEs 115 with different capabilities without configuring an MBS CFR or BWP). For example, the network entity 105-a may transmit second control signaling (e.g., control signaling separate from the control signaling 205, such as a SIB) that indicates downlink and uplink configurations for UEs 115 having different types or capabilities, such that the downlink and uplink configurations may be used for various services or types of services. As an example, a SIB may broadcast the downlink and uplink configurations to UEs 115 of different types or having different capabilities.

The network entity 105-a may indicate, in a second message (e.g., a message that is the same or different as the message 210) an association ID indicative of a type of the UE 115-a to configure MBS services for the UE 115-a while the UE 115-a operates in an RRC idle or RRC inactive mode. For example, the association ID may be indicative of the UE type (e.g., an MBS UE type), the RNTI for a service, a PDCCH configuration, a PDSCH configuration, a DRX configuration, and a WUS configuration (e.g., asstID={UE_typeo, RNTI( ), PDCCH( ), PDSCH( ), DRX( ), WUS( )}). As an example, a first association ID may be used for a first type of UE 115 (e.g., an enhanced mobile broadband (eMBB) UE 115) and may indicate first PDCCH, PDSCH, and PUSCH configurations (e.g., PDCCH1/PDSCH1/PUSCH1) for a first bandwidth (e.g., BW1, which may be less than or equal to 100 MHz). As another example, a second association ID may be used for a second type of UE 115 (e.g., a reduced capability (RedCap) UE 115) and may indicate second PDCCH, PDSCH, and PUSCH configurations (e.g., PDCCH2/PDSCH2/PUSCH2) for a second bandwidth (e.g., BW2, which may be less than or equal to 20 MHz). As another example, a third association ID may be used for a third type of UE 115 (e.g., an enhanced RedCap (eRedCap) UE 115 supporting peak rate (PR) 3 or bandwidth 3) and may indicate third PDCCH, PDSCH, and PUSCH configurations (e.g., PDCCH2/PDSCH3/PUSCH3) for a third bandwidth (e.g., BW3, which may be less than or equal to 5 MHz). In some other examples, the network entity 105-a may transmit a suspend message (e.g., RRC_SUSPEND) to the UE 115-a including a configuration ID (e.g., cfg_id) for the UE 115-a to use for MBS services while operating in an RRC inactive mode. For example, the network entity 105-a may indicate the configuration ID via an association ID in a dynamic message (e.g., asstID={cfg_ido, RNTI( ), PDCCH( ), PDSCH( ), DRX( ), WUS(}). In some examples, the network entity 105-a may map the configuration ID to corresponding services or capabilities of the UE 115-a.

In some examples, the network entity 105-a may configure the UE 115-a to support SDT while operating in an RRC idle or RRC inactive mode. For example, the network entity 105-a may configure the UE 115-a to support SDT without configuring a BWP (e.g., without configuring SDT-dedicated BWPs for uplink or downlink SDT). In some cases, the network entity 105-a may transmit the second control signaling (e.g., during RRC release) to the UE 115-a indicating an access service (AS) configuration (e.g., AS-config) and a suspend configuration (e.g., suspend-Config) that configure downlink and uplink configurations for a CG-SDT, which the UE 115-a may use for SDT services. For example, the network entity 105-a may indicate an association ID (e.g., in a dynamic message) indicating an RNTI for a service, a PDCCH configuration, a PDSCH configuration, a PUSCH configuration, and a CG configuration (e.g., asstID={RNTI( ), PDCCH( ), PDSCH( ), PUSCH( ), CG( )}, where the RNTI may be for the SDT (e.g., the RNTI may be a CG-SDT-CS-RNTI).

In some examples, the network entity 105-a may configure the UE 115-a to support SDT when the UE 115-a moves between different cells while operating in an RRC idle or RRC inactive mode (e.g., SDT can be continuously supported if the SIB indicates the SDT configuration). For example, the network entity 105-a may support different SDT configurations for UEs 115 with different capabilities without configuring an SDT BWP. In some cases, the network entity 105-a may transmit a SIB (e.g., in a broadcast transmission) indicating downlink and uplink configurations for UEs 115 having different types or capabilities, which can be used for different services or types of services. The network entity 105-a may indicate an association ID indicative of a UE type (e.g., an SDT UE type), an RNTI for the service, a PDCCH configuration, a PDSCH configuration, and a CG configuration (e.g., asstID={UE type( ), RNTI( ), PDCCH( ), PDSCH( ), CG( )}, which may indicate parameters for a candidate configuration similar to the configurations described with reference to an MBS UE 115 operating in the RRC idle or RRC inactive mode. In some other examples, the network entity 105-a may transmit a suspend message (e.g., RRC_SUSPEND) to the UE 115-a including a configuration ID (e.g., cfg_id) for the UE 115-a to use for SDT services while operating in an RRC inactive mode (e.g., similar to the configuration ID described with reference to an MBS UE 115 operating in the RRC idle or RRC inactive mode).

According to the configuration information received from the network entity 105-a (e.g., via the control signaling 205 and/or second control signaling) and the activation of a candidate configuration 225 via the message 210, the UE 115-a may perform communications 215 with the network entity 105-a. For example, the communications 215 may include the UE 115-a communicating information in an RRC active mode for a service or type of service in accordance with a candidate configuration 225 that is indicated by the message 210 (e.g., indicated by an association ID 230 and an RNTI for the service). In some cases, the UE 115-a may perform the communications 215 via a BWP configured by the control signaling 205 (e.g., the communications 215 may include uplink communications via an uplink BWP, downlink communications via a downlink BWP, or both), which may include operating according to a DRX configuration, receiving PDCCH messages, PDSCH messages, or WUSs, transmitting PUCCH messages or PUSCH messages, or any combination thereof in accordance with a candidate configuration 225 configured by the control signaling 205 and activated by the message 210. Additionally, or alternatively, the communications 215 may include the UE 115-a communicating information in an RRC idle or RRC inactive mode for services (e.g., MIBS services, SDT services) according to a candidate configuration configured by second control signaling and activated by a second message.

Such techniques may improve flexibility of BWP configurations, configurations for UEs 115 operating in an RRC idle or RRC inactive mode, or both, and may reduce signaling overhead, latency, and processing complexity associated with configuring additional BWPs for different types of services or UEs 115 of different types or capabilities (e.g., mitigating configuration signaling and BWP switching). By including the flexible parameters in configurations, the network entity 105-a may support activating and deactivating different candidate configurations 225 according to upcoming services, thereby simplifying signaling and processes associated with communicating information for different services or types of services with the UE 115-a.

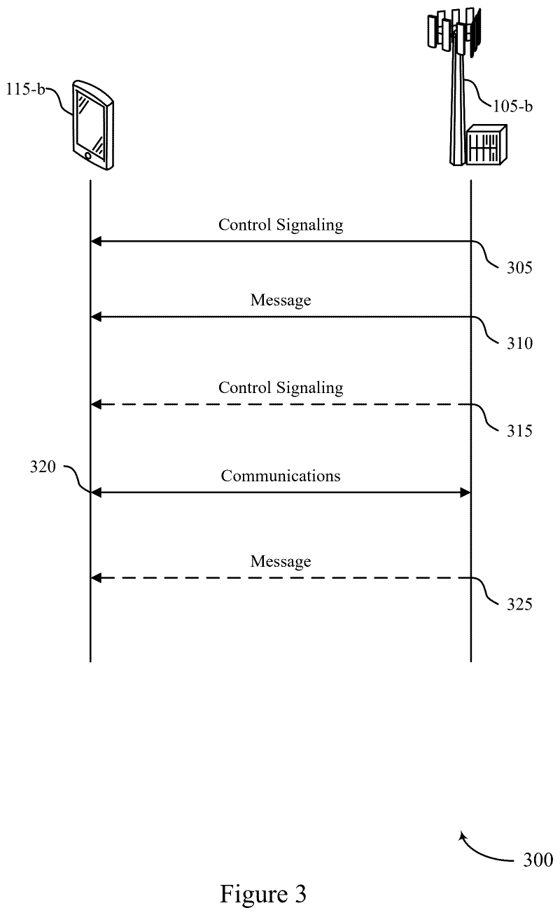

FIG. 3 shows an example of a process flow 300 that supports flexible configurations for different services and devices in wireless communications systems. The process flow 300 may implement, or be implemented by, one or more aspects of the wireless communications system 100 and the signaling configuration 200. For example, the process flow 300 illustrates signaling between and operations by a UE 115-b and a network entity 105-b, which may be examples of corresponding devices described with reference to FIGS. 1 and 2. In some examples, the process flow 300 may support the network entity 105-b providing the UE 115-b with flexible configurations for communicating information according to various services and types of services (e.g., unicast services, multicast services, broadcast services) as well as configurations applicable to various types of UEs 115 (e.g., eMMB UEs 115, RedCap UEs 115, eRedCap UEs 115). Alternative examples of the following may be implemented, where some processes are performed in a different order than described or are not performed. In some cases, processes may include additional features not mentioned below, or further processes may be added.

At 305, the network entity 105-b may transmit, to the UE 115-b, control signaling. In some examples, the control signaling may be an example of RRC signaling (e.g., an RRC configuration message). The control signaling may include a BWP configuration that allocates a BWP for subsequent communications by the UE 115-b. For example, the BWP configuration may indicate parameters for the UE 115-b to communicate via a downlink BWP, an uplink BWP, or both. In some cases, the BWP configuration may be for the UE 115-b to perform the subsequent communications while the UE 115-b operates in a connected mode (e.g., an RRC connected or active mode). The BWP configuration may indicate multiple candidate configurations for the subsequent communications via the BWP and may map each candidate configuration of the multiple candidate configurations to a respective association ID of a respective type of service (or service of the type of service) supported by each candidate configuration. In some cases, the multiple candidate configurations may include one or more uplink configurations, one or more downlink configurations, one or more DRX configurations, or any combination thereof.

In some cases, the one or more downlink configurations indicated via the control signaling may include one or more PDSCH configurations (e.g., a list of PDSCH configurations). Each PDSCH configuration (e.g., a PDSCH-config(i)) of the one or more PDSCH configurations may include a FDRA that indicates a subset of frequency resources within the BWP allocated for a PDSCH, a quantity of MIMO layers for the PDSCH, or both. Additionally, or alternatively, the one or more downlink configurations indicated via the control signaling may include one or more PDCCH configurations, one or more PDSCH configurations, and one or more SPS configurations. Each PDCCH configuration (e.g., a PDCCH-config(j)) of the one or more PDCCH configurations may include a set of one or more CORESETs for a respective PDCCH, a set of one or more SS sets of the respective PDCCH, or both. In some examples, the one or more PDCCH configurations may include a single PDCCH configuration that indicates multiple CORESETs of a downlink control channel, multiple SS sets of the downlink control channel, or both.

In some cases, the control signaling may include one or more IDs (e.g., RNTIs) for one or more respective types of services (or services of the respective types of services). In some examples, the RNTIs may be configured for the UE 115-b separately from the control signaling, and the control signaling my indicate RNTIs of the configured RNTIs for communicating according to different types of services. In some cases, the mapping between association IDs 230 and types of services may map the one or more DRX configurations with an associated service RNTI. In some cases, the multiple candidate configurations may include one or more WUS configurations. In some examples, each WUS configuration of the one or more WUS configurations may be mapped to at least one DRX configurations of the one or more DRX configurations indicated via the control signaling. In some other examples, each WUS configuration of the one or more WUS configurations may be mapped to at least one PDCCH configuration of the one or more downlink configurations indicated via the control signaling.

In some examples, the one or more uplink configurations indicated via the control signaling may include one or more PUCCH configurations. Each PUCCH configuration of the one or more PUCCH configurations may indicate whether a feedback process is enabled for a respective PUCCH, may indicate a codebook type of the respective PUCCH, or both. Additionally, or alternatively, the one or more uplink configurations indicated via the control signaling may include one or more PUSCH configurations. Each PUSCH configuration of the one or more PUSCH configurations may include a FDRA that indicates a subset of frequency resources within the BWP allocated for a PUSCH.

At 310, the network entity 105-b may transmit, to the UE 115-b, a message indicating an association ID of a type of service. In some cases, the message may be a dynamically communicated message (e.g., a MAC-CE or a DCI message) configured to activate or deactivate a candidate configuration indicated via the control signaling. For example, the association ID may be indicated of a configuration of the multiple candidate configurations that supports the type of service.

In some cases, the association ID may indicate a PDCCH configuration of the one or more PDCCH configurations indicated via the BWP configuration, a PDSCH configuration of the one or more PDSCH configurations indicated via the BWP configuration, and an SPS configuration of the one or more SPS configurations indicated via the BWP configuration, the PDDCH configuration, the PDSCH configuration, and the SPS configuration supporting the type of service. In some other examples, when the BWP configuration indicates a single PDCCH configuration, the association ID may indicate the single PDCCH configuration and a CORESET of the multiple CORESETs indicated via the single PDCCH configuration, a SS set of the multiple SS sets indicated via the single PDDCH configuration, or both that support the type of service. In some examples, the association ID may indicate a PUCCH configuration of the one or more PUCCH configurations indicated via the BWP configuration, a PUSCH configuration of the one or more PUSCH configurations indicated via the BWP configuration, or both that support the type of service.

In some cases, the association ID may indicate an ID of the one or more IDs indicated via the control signaling (e.g., an RNTI) and a DRX configuration of the one or more DRX configurations indicated via the control signaling. For example, the UE 115-b may operate according to the DRX configuration indicated by the association ID and the RNTI. In some cases, the association ID may indicate a WUS configuration of the one or more WUS configurations. For example, the association ID may indicate the WUS configuration based on the association ID indicating a DRX configuration that is mapped to the WUS configuration, or the association ID may indicate the WUS configuration as part of a candidate configuration (e.g., jointly configured with other configurations of the candidate configuration that includes a DRX configuration). As another example, the association ID may indicate the WUS configuration based on the association ID indicating a PDCCH configuration mapped to the WUS configuration, or the association ID may indicate the WUS configuration as part of a candidate configuration (e.g., jointly configured with other configurations of the candidate configuration that does not include a DRX configuration).

At 315, the network entity 105-b may transmit, to the UE 115-b, second control signaling. In some examples, the second control signaling may be associated with the UE 115-b communicating information in an RRC idle or RRC inactive mode. For example, the second control signaling may be or include a SIB or a suspend message (e.g., an RRC_SUSPEND command) indicating configurations for the UE 115-b to use while in an RRC idle or RRC inactive mode. The second control signaling may include one or more UE types for one or more types of services. Additionally, or alternatively, the second control signaling may include one or more second candidate configurations for performing a SDT according (e.g., one or more downlink configurations, one or more uplink configurations, or both for CG-SDT). In some examples, the second control signaling may include a configuration ID indicative of a configuration for the UE 115-b to use while operating in the RRC idle or RRC inactive mode for one or more types of service (e.g., MBS services, SDT services). In such examples, the network entity 105-b may map the configuration ID to corresponding types of services and capabilities of the UE 115-b.

At 320, the UE 115-b and the network entity 105-b may perform communications via the BWP and in accordance with the configuration of the candidate configurations indicated via the control signaling. For example, the UE 115-b and the network entity 105-b may communicate information for a type of service supported by the configuration based on the message indicating the association ID. For example, the UE 115-b may communicate the information for the type of service in accordance with a PDCCH configuration indicated by the association ID, a CORESET and SS set indicated by the association ID, a PDSCH configuration indicated by the association ID, a PUCCH configuration indicated by the association ID, a PUSCH configuration indicated by the association ID, a DRX configuration indicated by the association ID, a WUS configuration indicated by the association ID, or any combination thereof. In some examples, the UE 115-b may monitor for a WUS in accordance with the WUS configuration indicated by the association ID or mapped to a DRX configuration or PDCCH configuration indicated by the association ID.

At 325, the network entity 105-b may transmit, to the UE 115-b, a second message. In some examples, the second message may indicate for or otherwise trigger the UE 115-b to transition out of an RRC active mode (e.g., transition to an RRC idle or RRC inactive mode). In some examples, the second message may indicate a second association ID indicative of a second candidate configuration of the one or more second candidate configurations (e.g., configured by the second control signaling for use while the UE 115-b operates in the RRC idle or RRC inactive mode). For example, the second association ID may be indicative of a UE type for the UE 115-b, where the UE type of the UE 115-b may be based on capabilities of the UE 115-b while operating in the RRC idle or RRC inactive mode. As another example, the second association ID may be indicative of a second configuration of the one or more second candidate configurations for performing the SDT while operating in the RRC idle or RRC inactive mode, and the second association ID may further indicate the UE type for the UE 115-b. Additionally, or alternatively, the second association ID may indicate a configuration ID associated with a configuration for the UE 115-b to use for MBS or SDT services while operating in RRC idle or RRC inactive mode. In some cases, the UE 115-b may perform communications while operating in the RRC idle or RRC inactive mode according to the second configuration configured by the second control signaling and indicated by the second message. For example, the UE 115-b may communicate MBS information, SDT information, or both according to the second configuration.

Such techniques may improve flexibility of BWP configurations, configurations for UEs 115 operating in an RRC idle or RRC inactive mode, or both, and may reduce signaling overhead, latency, and processing complexity associated with configuring additional BWPs for different types of services or UEs 115 of different types or capabilities (e.g., mitigating configuration signaling and BWP switching). By including the flexible parameters in configurations, the network entity 105-b may support activating an deactivating different candidate configurations according to upcoming services, thereby simplifying signaling and processes associated with communicating information for different services or types of services with the UE 115-b.

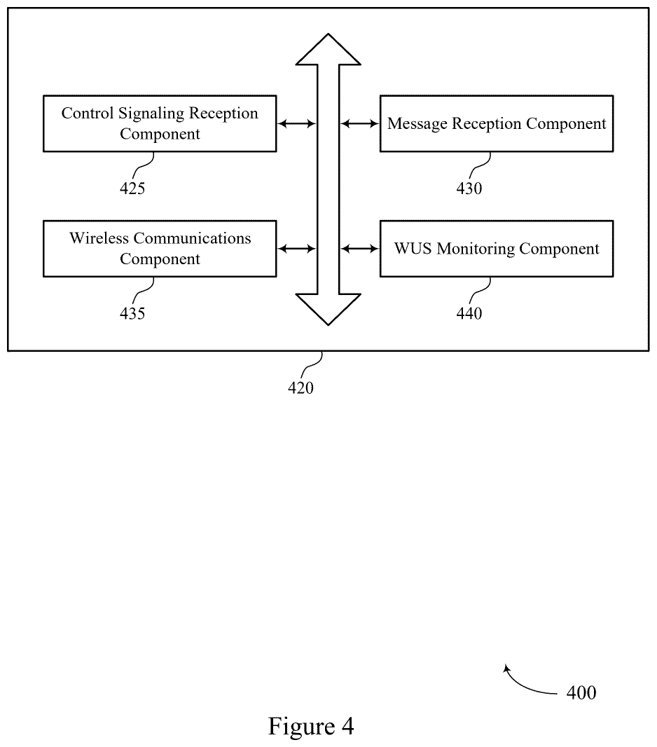

FIG. 4 shows an example 400 of a processing system 420 that supports flexible configurations for different services and devices in wireless communications systems. A processing system 420 may be an example of a processing system 140 (such as of a UE 115) and may include a control signaling reception component 425, a message reception component 430, a wireless communications component 435, a WUS monitoring component 440, or any combination thereof. A processing system 420, or various component thereof, may be an example of means for performing (such as a means for causing a UE 115 to perform) various techniques described herein.

The control signaling reception component 425 may be configured to cause the UE 115 to receive control signaling including a BWP configuration that allocates a BWP for subsequent communications by the UE, where the BWP configuration indicates a set of multiple candidate configurations for the subsequent communications via the BWP and maps each candidate configuration of the set of multiple candidate configurations to a respective association ID of a respective type of service supported by each candidate configuration, the set of multiple candidate configurations including one or more uplink configurations, one or more downlink configurations, one or more DRX configurations, or any combination thereof. The message reception component 430 may be configured to cause the UE 115 to receive a message indicating an association ID of a type of service, the association ID indicative of a configuration of the set of multiple candidate configurations that supports the type of service. The wireless communications component 435 may be configured to cause the UE 115 to communicate, via the BWP and in accordance with the configuration, information for the type of service based on the message indicating the association ID.

In some examples, the one or more downlink configurations indicated via the control signaling include one or more PDSCH configurations, each PDSCH configuration of the one or more PDSCH configurations including a FDRA that indicates a subset of frequency resources within the BWP allocated for a PDSCH, a quantity of MIMO layers for the PDSCH, or both.

In some examples, the one or more downlink configurations indicated via the control signaling include one or more PDCCH configurations, one or more PDSCH configurations, and one or more SPS configurations; the association ID indicates a PDCCH configuration of the one or more PDCCH configurations, a PDSCH configuration of the one or more PDSCH configurations, and a SPS configuration of the one or more SPS configurations that support the type of service; and communicating the information for the type of service is in accordance with the PDCCH configuration indicated by the association ID.

In some examples, each PDCCH configuration of the one or more PDCCH configurations includes a set of one or more CORESETs for a respective PDCCH, a set of one or more SSs of the respective PDCCH, or both; and each PDSCH configuration of the one or more PDSCH configurations includes a FDRA for a respective PDSCH, a quantity of MIMO layers for the respective PDSCH, or both.

In some examples, the one or more PDCCH configurations include a single PDCCH configuration that indicates a set of multiple CORESETs of a downlink control channel, a set of multiple SS sets of the downlink control channel, or both; the association ID further indicates the single PDCCH configuration and a CORESET, of the set of multiple CORESETs indicated via the single PDCCH configuration, a SS set, of the set of multiple SS sets indicated via the single PDCCH configuration, or both that supports the type of service; and communicating the information for the type of service is further accordance with the CORESET, the SS set, or both indicated by the association ID.

In some examples, the control signaling includes one or more IDs for one or more respective types of service; and the association ID indicates an ID of the one or more IDs indicated via the control signaling and a DRX configuration of the one or more DRX configurations indicated via the control signaling based on the ID.

In some examples, the plurality of candidate configurations further include one or more WUS configurations, the association identifier indicates a WUS configuration of the one or more wakeup signal configurations, and, to support communicating the information for the type of service, the WUS monitoring component 440 may be configured to cause the UE 115 to monitor for a WUS in accordance with the WUS configuration based on the association ID.

In some examples, each WUS configuration of the one or more WUS configurations is mapped to at least one DRX configuration of the one or more DRX configurations indicated via the control signaling; and the association ID indicates the WUS configuration based on the association ID indicating a DRX configuration that is mapped to the WUS configuration.

In some examples, each WUS configuration of the one or more WUS configurations is mapped to at least one PDCCH configuration of the one or more downlink configurations indicated via the control signaling; and the association ID indicates the WUS configuration based on the association ID indicating a PDCCH configuration mapped to the WUS configuration.

In some examples, the one or more uplink configurations indicated via the control signaling include one or more PUCCH configurations; each PUCCH configuration of the one or more PUCCH configurations indicates whether a feedback process is enabled for a respective PUCCH, indicates a codebook type of the respective PUCCH, or both; the association ID further indicates a PUCCH configuration, of the one or more PUCCH configurations, that supports the type of service; and communicating the information for the type of service is further accordance with the PUCCH configuration indicated by the association ID.

In some examples, the control signaling reception component 425 may be configured to cause the UE 115 to receive second control signaling including one or more UE types for one or more types of services. In some examples, the message reception component 430 may be configured to cause the UE 115 to receive a second message indicating a second association ID, where the second association ID is indicative of a UE type for the UE, and where the UE type for the UE is based on capabilities of the UE while operating in a radio resource control idle or inactive mode.

In some examples, the control signaling reception component 425 may be configured to cause the UE 115 to receive second control signaling including one or more second candidate configurations for performing a SDT. In some examples, the message reception component 430 may be configured to cause the UE 115 to receive a second message indicating a second association ID indicative of a second configuration of the one or more second candidate configurations for performing the SDT while operating in a radio resource control idle or inactive mode.

In some examples, the second association ID further indicates a UE type for the UE that is based on capabilities of the UE while operating in an idle or inactive mode.

In some examples, the one or more uplink configurations indicated via the control signaling include one or more PUSCH configurations, each PUSCH configuration of the one or more PUSCH configurations including a FDRA that indicates a subset of frequency resources within the BWP allocated for a PUSCH.

In some examples, the type of service includes a unicast service, a multicast service, or a broadcast service.

In some examples, the message indicating the association ID includes a MAC-CE or a DCI message.

A processing system 420 may include or be a component of one or more chips, systems-on-chips (SoCs), chipsets, packages, components, or devices that individually or collectively constitute or include a processing system. A processing system 420 may interface with other components of a processing system 420. For example, operations described with reference to a processing system 420, or various components thereof, may be performed by or with other such components, including a receiver, a transmitter, a transceiver, a modem, a user interface, a modulator/demodulator, an encoder/decoder, or any combination thereof (such as of the processing system 420, coupled with the processing system 420, of a processing system 420).

By including or configuring a processing system 420 for operation in a processing system 420 as described herein, the processing system 420 may support techniques for reduced signaling overhead, latency, and processing complexity associated with configuring multiple BWP configurations and performing BWP switching to support communications according to different types of services.

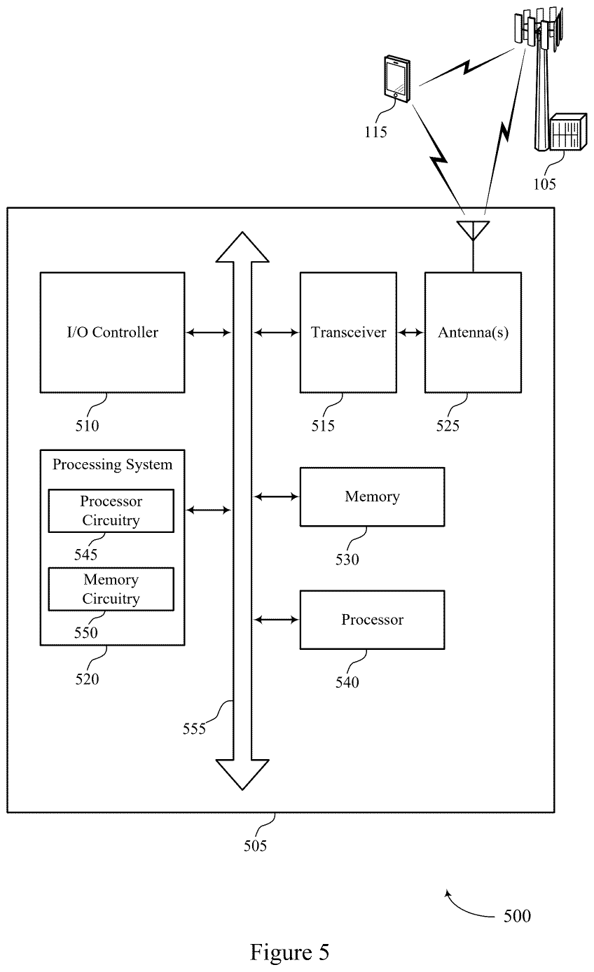

FIG. 5 shows an example of a system 500 including a device 505 that supports flexible configurations for different services and devices in wireless communications systems. The device 505 may be an example of or include components of UE 115. The device 505 may communicate (such as wirelessly) with one or more other devices (such as network entities 105, UEs 115). The device 505 may include components for transmitting and receiving communication, which may include a processing system 520, an input/output (I/O) controller, such as an I/O controller 510, a transceiver 515, antenna(s) 525, a memory 530, and a processor 540. Components of the device 505 may be coupled (such as operatively, communicatively, functionally, electronically, electrically, in electronic communication) a bus 555.

The transceiver 515 may support bi-directional communication via antenna(s) 525, and may support transmission operations, reception operations, or both, as described herein. The transceiver 515 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 505). The transceiver 515 may modulate symbols and provide the modulated symbols to antenna(s) 525 for transmission, and demodulate symbols from signals received using antenna(s) 525.

The processor 540 may be a general-purpose processing component that supports various operations (such as applications) of the device 505. The memory 530 may be a general-purpose storage component that stores code executable by the processor 540. Such code may include instructions that, when executed by the processor 540, cause the device 505 to perform various functions (such as to support an application of the device 505). The I/O controller 510 may manage inputs and outputs for the device 505, may manage peripherals not integrated into the device 505, or may represent a physical connection (such as port) to an external peripheral. The processor 540 may interact with a modem, a keyboard, a mouse, a touchscreen, or other device (such as via I/O controller 510). In some implementations, a user may interact with the device 505 via the I/O controller 510 or via hardware components controlled by the I/O controller 510.

The processing system 520 may be an example of a processing system 140 or a processing system 420. For example, the processing system 520 may include processor circuitry 545 and memory circuitry 550 that stores code, and may be configured to cause the device 505 to perform operations that support flexible configurations for different services and devices in wireless communications systems. Although the processing system 520 is illustrated as a separate component, which may involve a separate chip, chipset, or other module, in some implementations, one or more functions described with reference to the processing system 520 may be supported by or performed by a transceiver 515, antenna(s) 525, a processor 540, memory 530, or any combination thereof, such that a processing system 520 may include one or more of a transceiver 515, antenna(s) 525, a processor 540, memory 530, or any combination thereof.

By including or configuring the processing system 520 for operation in the device 505 as described herein, may support techniques for reduced signaling overhead, latency, and processing complexity associated with configuring multiple BWP configurations and performing BWP switching to support communications according to different types of services.

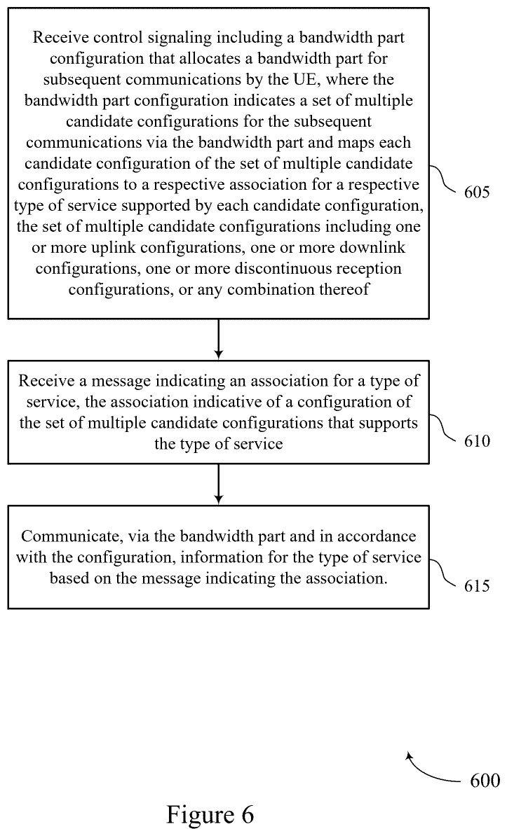

FIG. 6 shows an example of a method 600 that supports flexible configurations for different services and devices in wireless communications systems. Operations of the method 600 may be performed by a UE or its components (such as using a processing system configured to cause the UE 115 to perform one or more of the operations) as described herein.

At 605, the method may include receiving control signaling including a BWP configuration that allocates a BWP for subsequent communications by the UE, where the BWP configuration indicates a set of multiple candidate configurations for the subsequent communications via the BWP and maps each candidate configuration of the set of multiple candidate configurations to a respective association ID of a respective type of service supported by each candidate configuration, the set of multiple candidate configurations including one or more uplink configurations, one or more downlink configurations, one or more DRX configurations, or any combination thereof. In some examples, aspects of the operations of 605 may be performed by a control signaling reception component 425.

At 610, the method may include receiving a message indicating an association ID of a type of service, the association ID indicative of a configuration of the set of multiple candidate configurations that supports the type of service. In some examples, aspects of the operations of 610 may be performed by a message reception component 430.

At 615, the method may include communicating, via the BWP and in accordance with the configuration, information for the type of service based on the message indicating the association ID. In some examples, aspects of the operations of 615 may be performed by a wireless communications component 435.

Implementation examples are described in the following numbered clauses:

Aspect 1: A method for wireless communications at a UE, comprising: receiving control signaling comprising a BWP configuration that allocates a BWP for subsequent communications by the UE, wherein the BWP configuration indicates a plurality of candidate configurations for the subsequent communications via the BWP and maps each candidate configuration of the plurality of candidate configurations to a respective association for a respective type of service supported by each candidate configuration, the plurality of candidate configurations comprising one or more uplink configurations, one or more downlink configurations, one or more DRX configurations, or any combination thereof, receiving a message indicating an association for a type of service, the association indicative of a configuration of the plurality of candidate configurations that supports the type of service; and communicating, via the BWP and in accordance with the configuration, information for the type of service based at least in part on the message indicating the association.

Aspect 2: The method of aspect 1, wherein the one or more downlink configurations indicated via the control signaling comprise one or more PDSCH configurations, each PDSCH configuration of the one or more PDSCH configurations comprising a FDRA that indicates a subset of frequency resources within the BWP allocated for a PDSCH, a quantity of MIMO layers for the PDSCH, or both.

Aspect 3: The method of any of aspects 1 through 2, wherein the one or more downlink configurations indicated via the control signaling comprise one or more PDCCH configurations, one or more PDSCH configurations, and one or more SPS configurations; the association indicates a PDCCH configuration of the one or more PDCCH configurations, a PDSCH configuration of the one or more PDSCH configurations, and a SPS configuration of the one or more SPS configurations that support the type of service; and communicating the information for the type of service is in accordance with the PDCCH configuration indicated by the association.

Aspect 4: The method of aspect 3, wherein each PDCCH configuration of the one or more PDCCH configurations comprises a set of one or more CORESETs for a respective PDCCH, a set of one or more SSs of the respective PDCCH, or both; and each PDSCH configuration of the one or more PDSCH configurations comprises a FDRA for a respective PDSCH, a quantity of MIMO layers for the respective PDSCH, or both.

Aspect 5: The method of aspect 3, wherein the one or more PDCCH configurations comprise a single PDCCH configuration that indicates a plurality of CORESETs of a downlink control channel, a plurality of SS sets of the downlink control channel, or both; the association further indicates the single PDCCH configuration and a CORESET, of the plurality of CORESETs indicated via the single PDCCH configuration, a SS set, of the plurality of SS sets indicated via the single PDCCH configuration, or both that supports the type of service; and communicating the information for the type of service is further accordance with the CORESET, the SS set, or both indicated by the association ID

Aspect 6: The method of any of aspects 1 through 5, wherein the control signaling comprises one or more IDs for one or more respective types of service; and the association indicates an ID of the one or more IDs indicated via the control signaling and a DRX configuration of the one or more DRX configurations indicated via the control signaling based at least in part on the ID.

Aspect 7: The method of any of aspects 1 through 6, wherein the plurality of candidate configurations further comprises one or more WUS configurations, wherein the association indicates a WUS configuration of the one or more WUS configurations, and wherein communicating the information for the type of service comprises: monitoring for a WUS in accordance with the WUS configuration based at least in part on the association.

Aspect 8: The method of aspect 7, wherein each WUS configuration of the one or more WUS configurations is mapped to at least one DRX configuration of the one or more DRX configurations indicated via the control signaling; and the association indicates the WUS configuration based at least in part on the association indicating a DRX configuration that is mapped to the WUS configuration.

Aspect 9: The method of aspect 7, wherein each WUS configuration of the one or more WUS configurations is mapped to at least one PDCCH configuration of the one or more downlink configurations indicated via the control signaling; and the association indicates the WUS configuration based at least in part on the association indicating a PDCCH configuration mapped to the WUS configuration.

Aspect 10: The method of any of aspects 1 through 9, wherein the one or more uplink configurations indicated via the control signaling comprise one or more PUCCH configurations; each PUCCH configuration of the one or more PUCCH configurations indicates whether a feedback process is enabled for a respective PUCCH, indicates a codebook type of the respective PUCCH, or both; the association further indicates a PUCCH configuration, of the one or more PUCCH configurations, that supports the type of service; and communicating the information for the type of service is further accordance with the PUCCH configuration indicated by the association.

Aspect 11: The method of any of aspects 1 through 10, further comprising: receiving second control signaling comprising one or more UE types for one or more types of services; and receiving a second message indicating a second association, wherein the second association is indicative of a UE type for the UE, and wherein the UE type for the UE is based at least in part on capabilities of the UE while operating in a radio resource control idle or inactive mode.

Aspect 12: The method of any of aspects 1 through 11, further comprising: receiving second control signaling comprising one or more second candidate configurations for performing a SDT; and receiving a second message indicating a second association indicative of a second configuration of the one or more second candidate configurations for performing the SDT while operating in a radio resource control idle or inactive mode.

Aspect 13: The method of aspect 12, wherein the second association further indicates a UE type for the UE that is based at least in part on capabilities of the UE while operating in an idle or inactive mode.

Aspect 14: The method of any of aspects 1 through 13, wherein the one or more uplink configurations indicated via the control signaling comprise one or more PUSCH configurations, each PUSCH configuration of the one or more PUSCH configurations comprising a FDRA that indicates a subset of frequency resources within the BWP allocated for a PUSCH.

Aspect 15: The method of any of aspects 1 through 14, wherein the type of service comprises a unicast service, a multicast service, or a broadcast service.

Aspect 16: The method of any of aspects 1 through 15, wherein the message indicating the association comprises a MAC-CE or a DCI message.

Aspect 17: The method of any of aspects 1 through 16, wherein the message comprises an association ID indicative of the association.

Aspect 18: A UE for wireless communications, comprising a processing system that includes processor circuitry and memory circuitry that stores code, the processing system configured to cause the UE to perform a method of any of aspects 1 through 16.

Aspect 19: A UE for wireless communications, comprising at least one means for performing a method of any of aspects 1 through 16.

Aspect 20: A non-transitory computer-readable medium storing code for wireless communications, the code comprising instructions executable by one or more processors to perform a method of any of aspects 1 through 16.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling comprising a bandwidth part configuration that allocates a bandwidth part for subsequent communications by the UE, wherein the bandwidth part configuration indicates a plurality of candidate configurations for the subsequent communications via the bandwidth part and maps each candidate configuration of the plurality of candidate configurations to a respective association for a respective type of service supported by each candidate configuration, the plurality of candidate configurations comprising one or more uplink configurations, one or more downlink configurations, one or more discontinuous reception configurations, or any combination thereof,
receive a message indicating an association for a type of service, the association indicative of a configuration of the plurality of candidate configurations that supports the type of service; and
communicate, via the bandwidth part and in accordance with the configuration, information for the type of service based at least in part on the message indicating the association.

2. The UE of claim 1, wherein the one or more downlink configurations indicated via the control signaling comprise one or more physical downlink shared channel configurations, each physical downlink shared channel configuration of the one or more physical downlink shared channel configurations comprising a frequency domain resource allocation that indicates a subset of frequency resources within the bandwidth part allocated for a physical downlink shared channel, a quantity of multiple-input multiple-output layers for the physical downlink shared channel, or both.

3. The UE of claim 1, wherein:
the one or more downlink configurations indicated via the control signaling comprise one or more physical downlink control channel configurations, one or more physical downlink shared channel configurations, and one or more semi-persistent scheduling configurations;
the association indicates a physical downlink control channel configuration of the one or more physical downlink control channel configurations, a physical downlink shared channel configuration of the one or more physical downlink shared channel configurations, and a semi-persistent scheduling configuration of the one or more semi-persistent scheduling configurations that support the type of service; and
communicating the information for the type of service is in accordance with the physical downlink control channel configuration indicated by the association.

4. The UE of claim 3, wherein:
each physical downlink control channel configuration of the one or more physical downlink control channel configurations comprises a set of one or more control resource sets for a respective physical downlink control channel, a set of one or more search spaces of the respective physical downlink control channel, or both; and
each physical downlink shared channel configuration of the one or more physical downlink shared channel configurations comprises a frequency domain resource allocation for a respective physical downlink shared channel, a quantity of multiple-input multiple-output layers for the respective physical downlink shared channel, or both.

5. The UE of claim 3, wherein:
the one or more physical downlink control channel configurations comprise a single physical downlink control channel configuration that indicates a plurality of control resource sets of a downlink control channel, a plurality of search space sets of the downlink control channel, or both;
the association further indicates the single physical downlink control channel configuration and a control resource set, of the plurality of control resource sets indicated via the single physical downlink control channel configuration, a search space set, of the plurality of search space sets indicated via the single physical downlink control channel configuration, or both that supports the type of service; and
communicating the information for the type of service is further accordance with the control resource set, the search space set, or both indicated by the association.

6. The UE of claim 1, wherein:
the control signaling comprises one or more identifiers for one or more respective types of service; and
the association indicates an identifier of the one or more identifiers indicated via the control signaling and a discontinuous reception configuration of the one or more discontinuous reception configurations indicated via the control signaling based at least in part on the identifier.

7. The UE of claim 1, wherein the plurality of candidate configurations further comprises one or more wakeup signal configurations, wherein the association indicates a wakeup signal configuration of the one or more wakeup signal configurations, and wherein, to communicate the information for the type of service, the one or more processors are individually or collectively further operable to execute the code to cause the UE to:
monitor for a wakeup signal in accordance with the wakeup signal configuration based at least in part on the association.

8. The UE of claim 7, wherein:
each wakeup signal configuration of the one or more wakeup signal configurations be mapped to at least one discontinuous reception configuration of the one or more discontinuous reception configurations indicated via the control signaling; and
the association indicates the wakeup signal configuration based at least in part on the association indicating a discontinuous reception configuration that is mapped to the wakeup signal configuration.

9. The UE of claim 7, wherein:
each wakeup signal configuration of the one or more wakeup signal configurations be mapped to at least one physical downlink control channel configuration of the one or more downlink configurations indicated via the control signaling; and
the association indicates the wakeup signal configuration based at least in part on the association indicating a physical downlink control channel configuration mapped to the wakeup signal configuration.

10. The UE of claim 1, wherein:
the one or more uplink configurations indicated via the control signaling comprise one or more physical uplink control channel configurations;
each physical uplink control channel configuration of the one or more physical uplink control channel configurations indicates whether a feedback process is enabled for a respective physical uplink control channel, indicates a codebook type of the respective physical uplink control channel, or both;
the association further indicates a physical uplink control channel configuration, of the one or more physical uplink control channel configurations, that supports the type of service; and
communicating the information for the type of service is further accordance with the physical uplink control channel configuration indicated by the association.

11. The UE of claim 1, wherein the one or more processors are individually or collectively further operable to execute the code to cause the UE to:
receive second control signaling comprising one or more UE types for one or more types of services; and
receive a second message indicating a second association, wherein the second association is indicative of a UE type for the UE, and wherein the UE type for the UE is based at least in part on capabilities of the UE while operating in a radio resource control idle or inactive mode.

12. The UE of claim 1, wherein the one or more processors are individually or collectively further operable to execute the code to cause the UE to:
receive second control signaling comprising one or more second candidate configurations for performing a small data transmission; and
receive a second message indicating a second association indicative of a second configuration of the one or more second candidate configurations for performing the small data transmission while operating in a radio resource control idle or inactive mode.

13. The UE of claim 12, wherein the second association further indicates a UE type for the UE that is based at least in part on capabilities of the UE while operating in an idle or inactive mode.

14. The UE of claim 1, wherein the one or more uplink configurations indicated via the control signaling comprise one or more physical uplink shared channel configurations, each physical uplink shared channel configuration of the one or more physical uplink shared channel configurations comprising a frequency domain resource allocation that indicates a subset of frequency resources within the bandwidth part allocated for a physical uplink shared channel.

15. The UE of claim 1, wherein the type of service comprises a unicast service, a multicast service, or a broadcast service.

16. The UE of claim 1, wherein the message indicating the association comprises a medium access control control element or a downlink control information message.

17. The UE of claim 1, wherein the message comprises an association identifier indicative of the association.

18. A method for wireless communications at a user equipment (UE), comprising:
receiving control signaling comprising a bandwidth part configuration that allocates a bandwidth part for subsequent communications by the UE, wherein the bandwidth part configuration indicates a plurality of candidate configurations for the subsequent communications via the bandwidth part and maps each candidate configuration of the plurality of candidate configurations to a respective association for a respective type of service supported by each candidate configuration, the plurality of candidate configurations comprising one or more uplink configurations, one or more downlink configurations, one or more discontinuous reception configurations, or any combination thereof;
receiving a message indicating an association for a type of service, the association indicative of a configuration of the plurality of candidate configurations that supports the type of service; and
communicating, via the bandwidth part and in accordance with the configuration, information for the type of service based at least in part on the message indicating the association.

19. The method of claim 18, wherein the one or more downlink configurations indicated via the control signaling comprise one or more physical downlink shared channel configurations, each physical downlink shared channel configuration of the one or more physical downlink shared channel configurations comprising a frequency domain resource allocation that indicates a subset of frequency resources within the bandwidth part allocated for a physical downlink shared channel, a quantity of multiple-input multiple-output layers for the physical downlink shared channel, or both.

20. A non-transitory computer-readable medium storing code for wireless communications, the code comprising instructions executable by one or more processors to:
receive control signaling comprising a bandwidth part configuration that allocates a bandwidth part for subsequent communications by a user equipment (UE), wherein the bandwidth part configuration indicates a plurality of candidate configurations for the subsequent communications via the bandwidth part and maps each candidate configuration of the plurality of candidate configurations to a respective association for a respective type of service supported by each candidate configuration, the plurality of candidate configurations comprising one or more uplink configurations, one or more downlink configurations, one or more discontinuous reception configurations, or any combination thereof;
receive a message indicating an association for a type of service, the association indicative of a configuration of the plurality of candidate configurations that supports the type of service; and
communicate, via the bandwidth part and in accordance with the configuration, information for the type of service based at least in part on the message indicating the association.
